(19) United States
(12) Patent Application Publication
(10) Pub. No.: US 2012/0147864 A1
(43) Pub. Date: Jun. 14, 2012

(54) Synchronous Data Transmission in Hybrid Communication Networks for Transportation Safety Systems

(76) Inventors: Jianlin Guo, Newton, MA (US); Raymond Yim, Cambridge, MA (US); Philip V. Orlik, Cambridge, MA (US); Frederick J. Igo, JR., Ayer, MA (US); Chunjie Duan, Brookline, MA (US); Jinyun Zhang, Cambridge, MA (US)

(21) Appl. No.: 12/964,283

(22) Filed: Dec. 9, 2010

(51) Int. Cl. H04W 84/02

(52) U.S. Cl. 370/338

(57) ABSTRACT

A hybrid communication network for a transportation safety system includes a wired network including a set of fixed nodes. Each fixed node includes a wired interface for connecting the fixed node to the wired network and at least one wireless interface. The set of fixed nodes further includes a head node at a first end of the wired network connected to a controller, a terminal node at a second end of the wired network, and a set of relay nodes arranged between the head node and the terminal node. A wireless network includes a set of mobile nodes and a set of fixed nodes connected to the wired network. Each mobile node includes at least one of the wireless interfaces, and each mobile node is arranged in a moveable car.

### FIELD OF THE INVENTION

This invention relates generally to communication networks for transportation safety systems, and more particularly to synchronous wireless data transmission in hybrid communication systems.

### BACKGROUND OF THE INVENTION

Data communications in transportation safety systems require very high reliability and very low latency. For example, the International Electronic Commission (IEC) has set stringent safety and reliability requirements on communication networks in elevator systems. Only one error is allowed in approximately 10¹⁵ safety related data packets. The latency requirement for high priority data packets can be as low as a few milliseconds.

Conventional safety systems are typically implemented with a dedicated wired communication networks. For example, to send safety data packets between a controller and a car in an elevator system, a heavy communication cable in an elevator shaft is connected to a moveable car.

Recently, wireless communication technologies have been applied to safety systems to reduce cost and increase scalability. Communication Based Train Control (CBTC) is an example. The communication network in safety systems usually includes multiple fixed nodes such as trackside nodes for CBTC systems, and multiple mobile nodes arranged in train cars. The fixed nodes are connected by a wired network such as Ethernet. Fixed nodes are also capable of transmitting and receiving (transceiving) data wirelessly. A controller for the safety system is typically connected to at least one fixed node via a wired interface. Data packets are transmitted from the controller to a fixed node via the wired interface, and relayed hop-by-hop to all other fixed nodes via the wired network. Then, the fixed nodes retransmit the data packet to the mobile nodes using the wireless network. Mobile nodes communicate data packets via the wireless network to the fixed nodes. Fixed nodes receive the data, and then relay the data to the fixed node connected to the controller via the wired network.

However, the specifications of existing CBTC systems are insufficient in some aspects. The latency is in the order of seconds due to the use of a conventional Carrier Sense Multiple Access (CSMA) for the wireless network, and the handover process at mobile nodes. Additionally, message error rates can be as high as 10⁻⁸.

Therefore, it is desired to develop a communication network for safety systems that achieves higher reliability, such as a message error rate of 10⁻¹⁵, and a latency of a few milliseconds.

### SUMMARY OF THE INVENTION

Embodiments of the invention provide a method for synchronous transmission in a multihop hybrid communication networks to enable high reliability and low latency for transportation safety systems.

### BRIEF DESCRIPTION OF THE DRAWINGS

FIG. 1 is a schematic of a multihop hybrid wireless communication network for safety systems according to embodiments of the invention;

FIG. 2 is a block diagram of a format of a synchronization packet according to embodiments of the invention;

FIG. 3A is a timing diagram of a synchronization process for fixed nodes according to embodiments of the invention;

FIG. 3B is a schematic of flight time according to embodiments of the invention;

FIG. 3C is a timing diagram of a precise time synchronization process for fixed nodes;

FIG. 4 is schematic of frames for packet transmission over the wireless network according to embodiments of the invention; and

FIG. 5 is a schematic of synchronous data packet transmission over the hybrid network according to embodiments of the invention;

### DETAILED DESCRIPTION OF THE PREFERRED EMBODIMENT

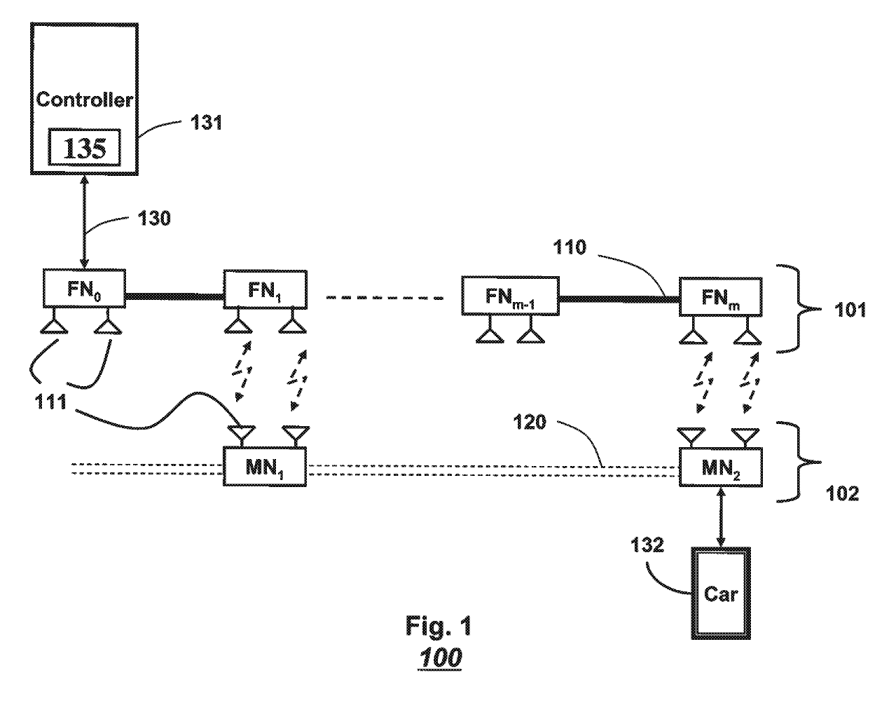

As shown in FIG. 1, a multihop hybrid communication network 100 includes a wired network 101 and a wireless network 102. The hybrid network can be used for high reliability and low latency communication. The wired network includes a set of m+1 fixed nodes FN₀, FN₁, FN₂, . . . , FNₘ. Each fixed node (FN) is equipped with at least two communication interfaces, one to a wired backbone 110, and one or more wireless transceivers 111. The wireless network 102 includes a set of mobile nodes MN₁ and MN₂. Each mobile node (MN) is also equipped with one or more wireless transceivers.

All fixed nodes are arranged along trajectory 120 such as an elevator car moving in a shaft, or a car moving on a train track. The FNs are arranged linearly, although not necessarily a straight line. All FNs are connected via the wired backbone, such as fiber optic cable. MNs generally move along the trajectory. The underlying physical layer protocol used on the backbone is arbitrary.

Sources and sinks of data in the network include a controller 131, such as elevator controller or train controller, and an elevator or train car 132. The safety related data are transmitted as packets.

The controller is connected to a FN via a wired interface 130, not necessarily the same as the wired backbone. In the preferred embodiment, it is assumed that the controller is connected to the FN at a first end of the linearly arranged network, say FN₀ as shown in FIG. 1. If the controller is connected to the FN located elsewhere, then it is possible to partition the wired network into two sub-networks so that the controller is connected to FNs located at the end of each respective sub-networks.

The FNs can be classified into three types of nodes. The FN that is connected to the controller 131 is called a head node. The head node is a source and sink for safety related data packets in the network. In FIG. 1, FN₀ is the head node.

The FN that is located at the second end of the network is called a terminal node. In FIG. 1, FNₘ is a terminal node.

All remaining FNs form a set of (one or more) relay nodes that pass packets to adjacent FNs. The FNs also communicates with the MNs wirelessly. Packets generated 135 in the controller and transmitted from the head node to MNs in the cars are called downlink packets. Packets generated by cars and transmitted from the MNs to the head node and the controller are called uplink packets.

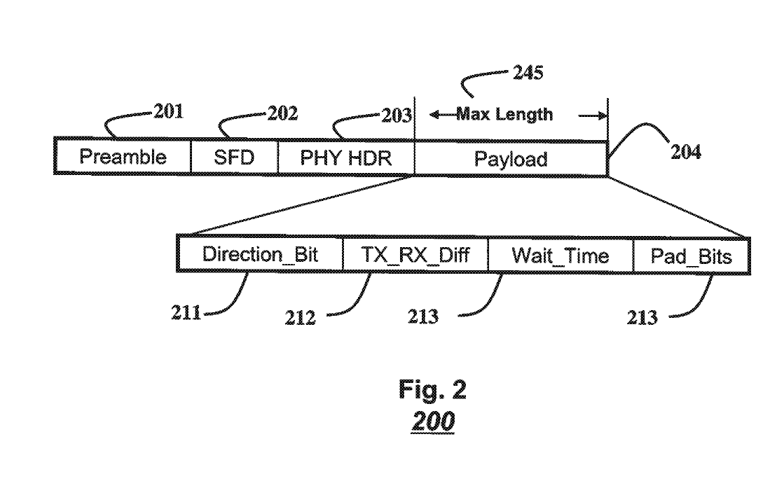

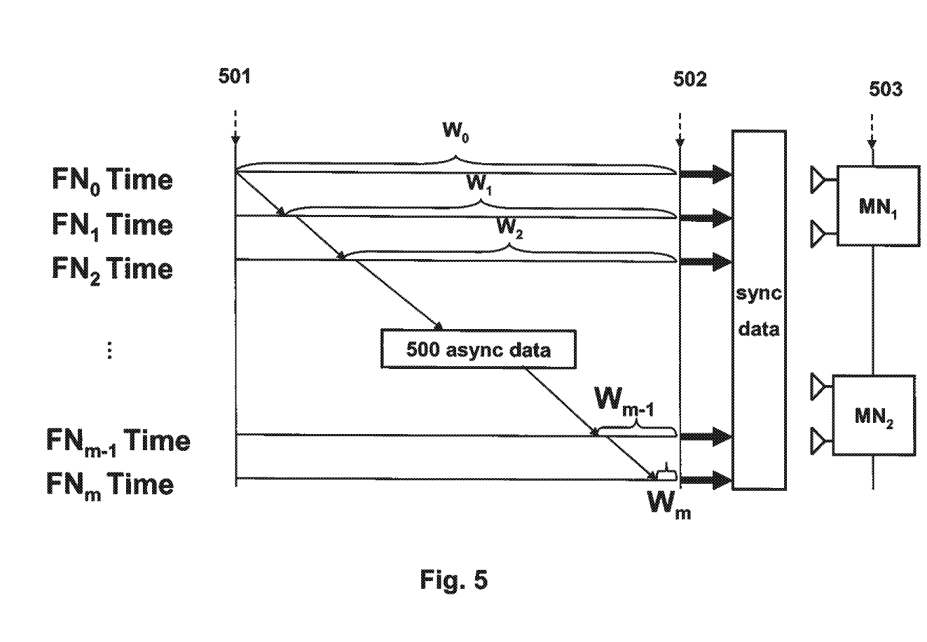

The hybrid network uses Sync packets 200, time packets 300, and data packets 500. A synchronization packet (Sync) 200, see FIG. 2, is used in the wired backbone to synchronize the timing of fixed nodes for the transmissions of the data packets 500, see FIG. 5, from the fixed nodes to the mobile nodes. The format of the data packet 500 is arbitrary, depending on the network design. The embodiments can also use a time packet 300 to improve the preciseness of the synchronous transmissions.

Data packets wirelessly transmitted (broadcasted) by any mobile node are received essentially at the same time by all the fixed nodes within range of the mobile node, hence synchronization is not an issue for upward bound data packets.

In the prior art, data packets are usually transmitted asynchronously, this increases interference and latency. To minimize interference and latency, and also increase reliability, all the FNs transmit the downlink packets to the MNs synchronously via the wireless network.

Conventional CSMA and handover techniques cannot accomplish this task due to collisions and unpredictable channel access delay because of random back-off. The invention mitigates these problems. However, it cannot be guaranteed that the clocks used by the fixed nodes are synchronized with each other. Hence, the embodiments of the invention include a process and protocol to synchronously transmit data packet even if the clocks are unsynchronized.

Synchronous Wireless Transmission

The synchronous transmission of data packets 500 is achieved as follows. A data packet 500 from the controller 131 is first transmitted from the head node to the FN₁ via the wired backbone. Then, a relay process over wired backbone begins. The FN₁ relays the data packet to FN₂, FN₂ relays the packet to FN₃, . . . , and FNₘ₋₁ relays the packet to FNₘ. All the FNs eventually receive the data packet at instants staggered in time. Then, all the FNs synchronously transmit the data packet to the all MNs via the wireless network.

To do so, each FN determines a time latency from the time the FN receives a data packet from the backbone to the time the FN transmits the packet over the wireless network, so that all fixed nodes synchronously transmit the data packet over the wireless network, even when they receive data packets asynchronously from the wired backbone.

The embodiments include a quick and a precise synchronization scheme.

FIG. 2 shows a synchronization packet (Sync) 200 used to synchronize transmissions, even if the clocks at the FNs are asynchronous. The Sync packet includes a preamble 201, a start frame delimiter (SFD) 202, a physical header (PHY HDR) 203, and payload 204. Payload further includes a Direction_Bit 211, a TX_RX_Diff 212, a Wait_Time 213, and Pad_Bit 214.

The Direction_Bit indicates that the Sync packet is transmitted downwards in the direction from the head node to the terminal node, or upwards in the direction from the terminal node to the head node. To start, the head node FN₀ sets the Direction_Bit to downwards in the Sync packet transmitted to the FN₁. The terminal node FNₘ sets Direction_Bit to upwards in the Sync packet transmitted to FNₘ₋₁. Other FNs do not change Direction_Bit field.

TX_RX_Diff 212 and Wait_Time 213 are only used when the Sync packet is transmitted upwards. TX_RX_Diff 212 is the time difference between when the FN receives the downward Sync packet to the time the same node transmits the Sync packet upwards.

The Wait_Time 213 indicates the time the FN has to wait receiving the downlink packet before transmitting the packet over the wireless network. TX_RX_Diff 212 and Wait_Time 213 are set to zero in the downward Sync packet.

The Pad_Bits 214 field is set to zero. Pad_Bits 214 is used to pad Sync packet payload to a predetermined maximum payload (data) length 245. This guarantees a downlink data packet of any length can be synchronously transmitted over the wireless network by all FNs. That is, the padding bits that ensure that the length of the synchronization packet is greater than or equal to a longest data packet.

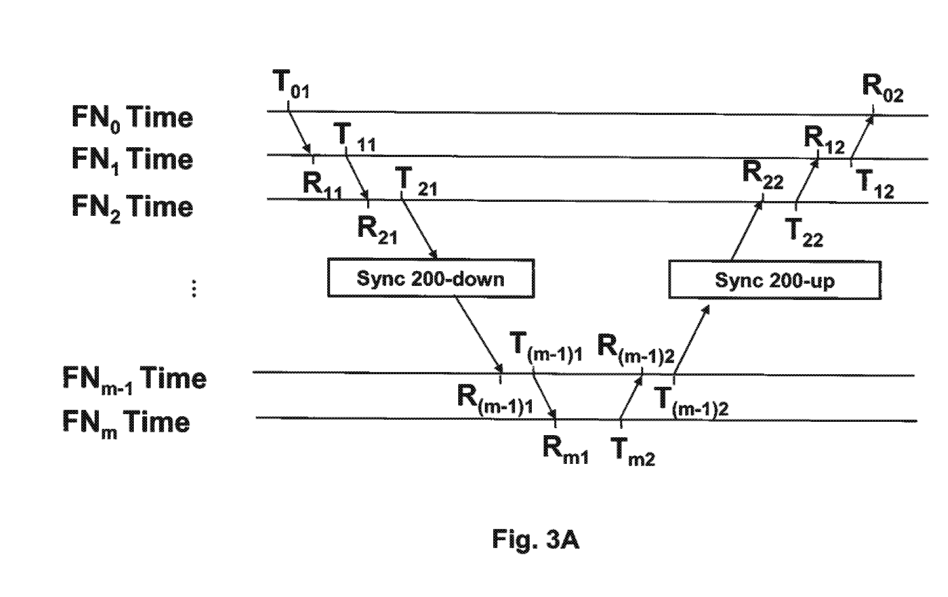

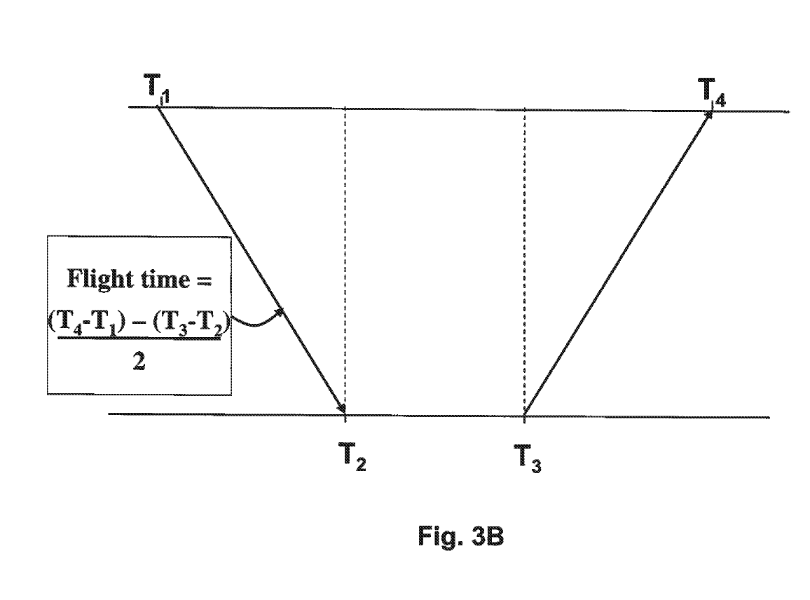

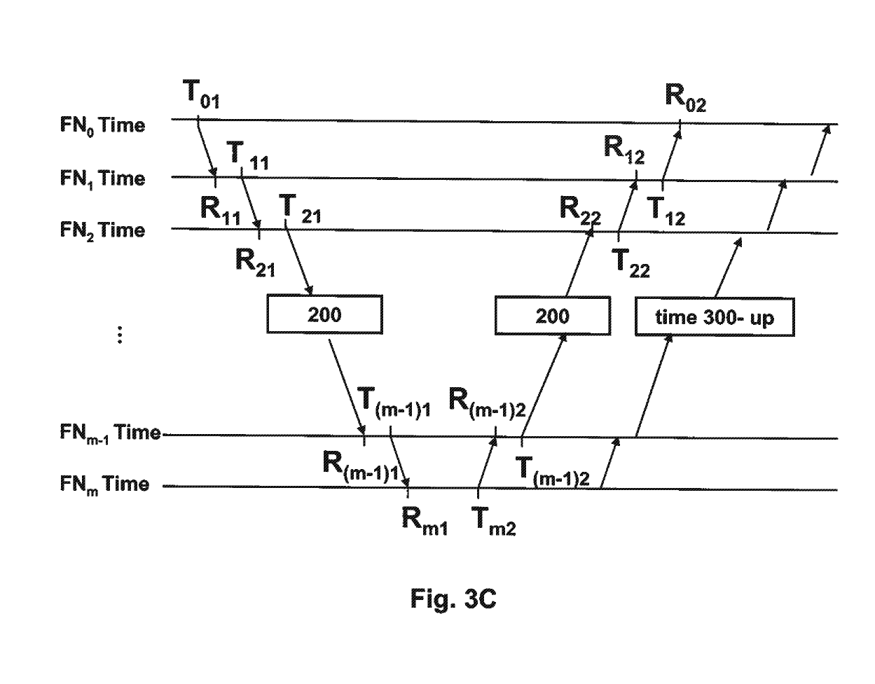

FIG. 3A shows a synchronization protocol according to embodiments of the invention. The Sync packet 200 from the head node FN₀ is relayed downward from the head node FN₀ to the terminal node FNₘ via the wired backbone. After the terminal FNₘ receives the Sync packet, the Sync packet is retransmitted upward to FN₀ via the wired backbone.

The time needed to transmit the packet down from the FN₀ to FNₘ via wired backbone and the waiting time at each FN before the node synchronously transmits the packet wirelessly is determined as follows.

In FIG. 3A, Tₖ₁ (k=0, 1, . . . , m−1) is the time instants when the Sync packet is transmitted down from node FNₖ to node FNₖ₊₁. Time Tₖ₁ is the time according to FNₖ at the beginning of the Sync packet transmission. Rₖ₁ (k=1, 2, . . . , m) denotes the time according to FNₖ when receiving the Sync packet from node FNₖ₋₁. Rₖ₂ (k=m−1, m−2, . . . 0) denotes the time according to the FNₖ when receiving the Sync packet from FNₖ₊₁. Tₖ₂ (k=m, m−1, . . . , 1) is a time pre-determined by FNₖ to begin transmitting the Sync packet up to FNₖ₋₁. FNₖ (k=m, m−1, . . . , 1) includes Tₖ₂−Rₖ₁ and the wait time Wₖ 213 in the Sync packet payload 204 when transmitting the Sync packet up to FNₖ₋₁.

The upward Sync packet transmission starts from the terminal node FNₘ. The terminal node determines the amount of time needed to convert packet received via the wired backbone at time Rₘ₁ into a transmission over the wireless network. The time difference Wₘ is the waiting time for the FNₘ node. In the upward Sync packet, the FNₘ sets the Direction_bit to upwards, TX_RX_Diff to Tₘ₂−Rₘ₁ and Wait_Time to Wₘ and transmits the Sync packet to FNₘ₋₁. After FNₘ₋₁ receives the Sync packet from FNₘ, FNₘ₋₁ determines the latency D₍ₘ₋₁₎ₘ from FNₘ₋₁ to FNₘ as

$${D}_{( m - 1 ) m} = {T}_{( m - 1 ) 1} - {R}_{( m - 1 ) 1} + \frac{( {R}_{( m - 1 ) 2} - {T}_{( m - 1 ) 1} ) - ( {T}_{m 2} - {R}_{m 1} )}{2} .$$

and its waiting time Wₘ₋₁ as

Wₘ₋₁=D₍ₘ₋₁₎ₘ+Wₘ

In general, after FNₖ (k=0, 1, 2, . . . , m−1) receives the upward Sync packet from FNₖ₊ᵢ, FNₖ determines the latency Dₖ₍ₖ₊₁₎ from FNₖ to FNₖ₊₁ as

$${D}_{k ( k + 1 )} = {T}_{k 1} - {R}_{k 1} + \frac{( {R}_{k 2} - {T}_{k 1} ) - ( {T}_{( k + 1 ) 2} - {R}_{( k + 1 ) 1} )}{2} ,$$

and the waiting time Wₖ as

Wₖ=Dₖ₍ₖ₊₁₎+Wₖ₊₁.

T₍ₖ₊₁₎₂−R₍ₖ₊₁₎₁ is received in the TX_RX_Diff field 212 in the upward Sync packet, and Wₖ₊₁ is received in the Wait_Time field 213 in the upward Sync packet.

For the head node FN₀, R₀₁ is set so that T₀₁−R₀₁ is the time needed by the head node to receive the packet from the controller to the time the node relays the Sync packet via the backbone.

The waiting time Wₖ (k=0, 1, 2, . . . , m) is

$${W}_{k} = {\sum }_{i = k}^{m - 1} {D}_{i ( i + 1 )} + {W}_{m} .$$

Total latency Dₜₒₜₐₗ from head node FN0 to terminal node FNm is

$${D}_{total} = {\sum }_{i = 0}^{m - 1} {D}_{i ( i + 1 )} .$$

The above equations use “time-of-flight” to determine the delay for packets between two adjacent fixed nodes, as shown in FIG. 3B.

Noticed that time Tₖ₂ is pre-determined because when FNₖ (k=m, m−1, . . . , 1) transmits the Sync packet to FNₖ₋₁, FNₖ needs to include time difference Tₖ₂−Rₖ₁ into Sync packet payload in advance.

FIG. 3C shows an extra step to improve the synchronization accuracy. To obtain the exact time Tₖ₂, a follow up time packet 300 is transmitted from FNₘ to FNₘ₋₁. The time packet contains exact time Tₘ₂ perceived and recorded by FNₘ (according to its clock) at the beginning of the Sync packet transmission when FNₘ transmits the Sync packet to FNₘ₋₁. After FNₘ₋₁ receives the time packet, it updates D₍ₘ₋₁₎ₘ and Wₘ₋₁. Then, FNₘ₋₁ transmits the time packet containing the exact time T₍ₘ₋₁₎₂ and Wₘ₋₁ to FNₘ₋₂. FNₘ₋₂ updates D₍ₘ₋₂₎₍ₘ₋₁₎ and Wₘ₋₂. This process continues until FN₀ updates the latency D₀₁ and the wait W₀.

Frame Structure Over Wireless Network

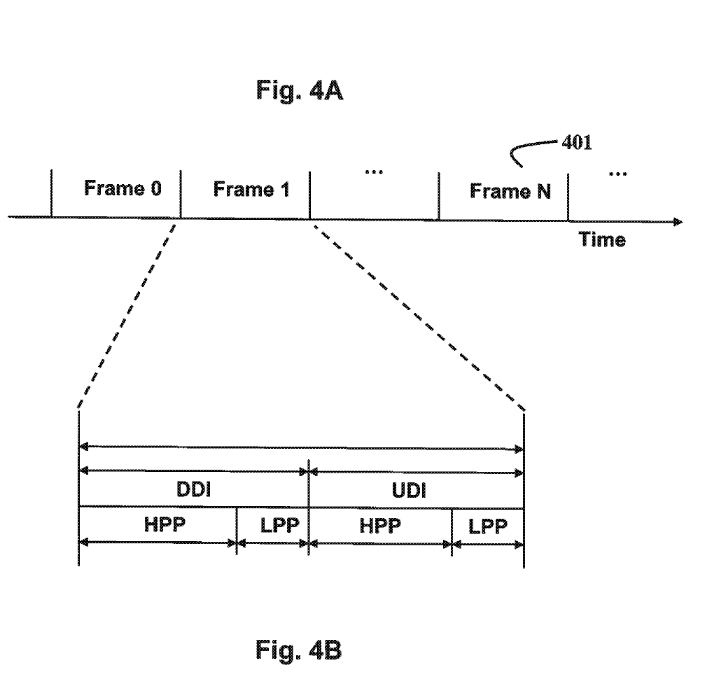

As shown in FIG. 4, time is partitioned into periodic frames 401 for synchronous downlink packets transmission over the wireless network. Multiple packets can be communicated during a frame.

Each frame of the wireless network is partitioned into a downlink data interval (DDI) and uplink data interval (UDI). That is, frames and associated uplink, downlink, and synchronization periods define the use of the wireless network between MNs and FNs. Communication between FNs can have a different framing as determined by the wired network.

The DDI and UDI are further partitioned into a high priority period (HPP) and a low priority period (LPP). The HPP is used to transmit high priority packets. The LPP is used to transmit low priority packets. Offsets of DDI and UDI are fixed.

Data Transmission

For downlink transmission, the data packets are transmitted from the head node, FN0, and relayed to all FNs via wired backbone. When FNₖ (k=0, 1, 2, . . . , m−1) receives a downlink packet from FNₖ₋₁, the node immediate relays the packet to FNₖ₊₁ via wired backbone, and duplicates the packet and places the packet into outgoing queue for the wireless network. The packet remains in the outgoing queue for Wₖ amount of time, and then the packet is synchronously transmitted to the MNs wirelessly in the DDI of the wireless frame structure defined in the embodiment.

FIG. 5 shows the synchronous packet transmission process, which includes the time 501 the FN₀ transmits data packet time step by time step to FNₘ via the wired backbone, and the time 502 all fixed nodes synchronously transmit packets wirelessly to the mobile nodes 503.

For uplink transmission, the MNs transmit packets wirelessly. All FNs that receive and successfully decode the packets wirelessly relay the packets to the head node FN₀ via wired backbone.

Data Retransmission

To avoid latency due to feedback, no packet acknowledgement is used. Rather, to increase reliability, each packet is transmitted multiple times over different frames as long as there is enough bandwidth, and a latency requirement is satisfied.

Alternatively, after a packet error, the sink indicates a retransmission request in the next outgoing data packet to the source. The source retransmits the failed packet as long as there is enough bandwidth and latency requirement is satisfied. The failed packet can be retransmitted separately or as part of a new data packet from the source.

Although the invention has been described with reference to certain preferred embodiments, it is to be understood that various other adaptations and modifications can be made within the spirit and scope of the invention. Therefore, it is the object of the append claims to cover all such variations and modifications as come within the true spirit and scope of the invention.

We claim:

1. A hybrid communication network for a transportation safety system, comprising:
a wired network including a set of fixed nodes, wherein each fixed node includes a wired interface for connecting the fixed node to the wired network and at least one wireless interface, and wherein the set of fixed nodes further comprises:
a head node at a first end of the wired network connected to a controller;
a terminal node at a second end of the wired network; and
a set of relay nodes arranged between the head node and the terminal node;
a wireless network including a set of mobile nodes, wherein each mobile node includes at least one of the wireless interfaces, and each mobile node is arranged in a moveable car associated with transportation safety system, and wherein the fixed nodes communicate with the wireless network via the at least one wireless interfaces; and
means for generating a data packet in the controller and transmitting the data packet to the head node, the set of relay node and the terminal node via the wired network, and wherein all the fixed nodes retransmit the data packet synchronously to all the mobile node after the terminal node receives the data packet.

2. The hybrid network of claim 1, further comprising:
relaying, in an upward direction and a downward direction, a synchronization packet to all the fixed nodes using the wired network to synchronize all of the fixed nodes.

3. The hybrid network of claim 2, wherein the synchronization packet includes padding bits that ensure that a length of the synchronization packet is greater than or equal to a longest data packet.

4. The network of claim 2, wherein, for each fixed node, the synchronization packet includes a time difference between when the fixed node receives the synchronization in the downward direction and when the fixed node retransmits the synchronization packet in the upward direction.

5. The network of claim 2, wherein, for each fixed node, the synchronization packet indicates a time the fixed node has to wait after receiving the synchronization packet in the downlink direction before retransmitting the synchronization packet in the upward direction.

7. A method for communicating data packets in hybrid communication network for a transportation safety system, comprising:
means for generating a data packet in a controller connected to the wireless network including a head node, a set of relay node and a terminal node;
transmitting the data packet to the fixed nodes; and
synchronizing retransmission of the data packet to mobile nodes of a wireless network, wherein each mobile node includes at least one of the wireless interfaces, and each mobile node is arranged in a moveable car associated with the of the transportation safety system.
